(19) United States
(12) Patent Application Publication
(10) Pub. No.: US 2020/0187082 A1
(43) Pub. Date: Jun. 11, 2020

(54) Systems and Methods for Active Detection, Avoidance, and Protection for Wireless Transmissions

(71) Applicant: Summit Wireless Technologies, Inc., Beaverton, OR (US)

(72) Inventors: Kenneth A. Boehlke, Portland, OR (US); Harold T. Davis, Hillsboro, OR (US)

(21) Appl. No.: 16/705,747

(22) Filed: Dec. 6, 2019

Related U.S. Application Data
(60) Provisional application No. 62/777,031, filed on Dec. 7, 2018.

(51) Int. Cl. H04W 36/30; H04W 24/08; H04W 48/02; G10L 19/113; G01S 7/02

(52) U.S. Cl. CPC H04W 36/30; H04W 24/08; H04W 84/12; G10L 19/113; G01S 7/021; H04W 48/02

(57) ABSTRACT

Systems and methods for reliably transmitting data over wireless channels. In particular, the present disclosure relates to systems and methods for transmitting audio over available DFS and non-DFS channels. The present disclosure can include a master device including a first front end for transmitting data over at least one wireless working channel, a second front end for monitoring at least one wireless prescreened channel, and a radar and energy detector unit for detecting the presence of radar or energy over the at least one wireless working channel and the at least one wireless prescreened channel. The master device can actively monitor a working channel while simultaneously prescreening a channel that can be used to replace the working channel in the event that radar, energy, or low network quality is experienced on the working channel. Both the working channel and the prescreened channel can be actively monitored for radar and energy.

### CROSS-REFERENCE TO RELATED APPLICATION(S)

This application claims priority to, and the benefit of, co-pending U.S. Provisional Application No. 62/777,031, filed Dec. 7, 2018, for all subject matter common to both applications. The disclosure of said provisional application is hereby incorporated by reference in its entirety.

### FIELD OF THE INVENTION

The present disclosure relates to systems and methods suitable for reliably transmitting data over wireless channels. In particular, the present disclosure relates to systems and methods for transmitting audio over available DFS and non-DFS channels.

### BACKGROUND

Generally, the 802.11 standard provides several distinct radio frequency ranges for use in Wi-Fi communications: 900 MHz 2.4 gigahertz (GHz), 3.6 GHz, 4.9 GHz, 5 GHz, 5.9 GHz and 60 GHz bands. Different countries apply their own regulations to allow users to operate within these frequency ranges. For example, in the United States, devices operating in the bands of 5.250-5.350 GHz and 5.470-5.725 GHz must employ dynamic frequency selection (DFS) to avoid interference with weather-radar and military applications.

Dynamic Frequency Selection (DFS) is a WiFi function that enables wireless local area networks (WLANs) to use 5 GHz frequencies that are generally reserved for radars. DFS frequency restrictions prohibit communications on DFS defined channels if a radar is detected. Specifically, the Wi-Fi DFS band can be shared with commercial and military radars, however by regulation, a DFS device must first monitor a channel for 60 seconds (Channel Availability Check, or CAC) without finding a radar signal before it can transmit on that channel. If a radar signal is detected, either while scanning or while transmitting, the DFS device must exit and stay off that channel for 30 minutes (Non-Occupancy Period). Therefore, wireless communications are often limited to devices configured to only communicate over non-Dynamic Frequency Selection (DFS) wireless channels to avoid interference with other communication devices operating within the DFS channels.

### SUMMARY

There is a need for improvements for how data is transmitted over wireless mediums. The present disclosure provides, in various embodiments solutions to address this need, in addition to having other desirable characteristics.

In accordance with example embodiments of the present invention, a method for wireless data transportation is provided. The method includes monitoring, by the working front end, over at least one wireless working channel for at least one of radar, energy, and network quality, evaluating, by the working front end, the at least one wireless working channel for acceptability of communications based on the monitoring, and switching, by the working front end, the at least one wireless working channel to a next wireless channel when the at least one wireless working channel is not acceptable for communications.

In accordance with aspects of the present invention, the at least one wireless working channel and the next wireless channel occupy the 5 gigahertz (GHz) Unlicensed National Information Infrastructure (U-NII) band. The at least one wireless working channel and the next wireless channel are one of Dynamic Frequency Selection (DFS) channels and non-DFS channels. The method can further include selecting the next wireless channel from a ranked list of Dynamic Frequency Selection (DFS) channels and non-DFS channels. The data can be audio data. The data can be uncompressed Pulse-code Modulation (PCM) audio data.

In accordance with example embodiments of the present invention, a method for prescreening wireless channels for data transportation is provided. The method includes monitoring, by a monitoring front end, a Dynamic Frequency Selection (DFS) channel for at least one of radar and energy, identifying, by the monitoring front end, the presence of radar or energy over the DFS channel, determining, by the monitoring front end, a next DFS channel, and switching, by the monitoring front end, the monitoring of the DFS channel to the next DFS channel.

In accordance with aspects of the present invention, the DFS channel and the next DFS channel occupy the 5 gigahertz (GHz) Unlicensed National Information Infrastructure (U-NII) band. The method can further include selecting the next DFS channel from a ranked list of DFS channels. The method can further include determining that radar has been detected over the next DFS from the ranked list of DFS channels over a predetermined period of time and selecting a next channel in the ranked list of DFS channels that radar has not been detected over the predetermined period of time. The next DFS channel can be monitored for 60 seconds without finding a radar signal before switching the DFS channel to the next DFS channel.

In accordance with example embodiments of the present invention, a system for data including a first front end for transmitting data over at least one wireless working channel, a second front end for monitoring at least one wireless prescreened channel, a radar and energy detector unit for detecting the presence of radar or energy over the at least one wireless working channel and the at least one wireless prescreened channel, and a baseband processor for transitioning from the at least one wireless working channel to the at least one wireless prescreened channel when communication over the at least one wireless working channel is no longer acceptable. The system also includes at least one slave device for receiving the data over the at least one wireless working channel.

In accordance with aspects of the present invention, the at least one slave device can include an RF front end for providing network quality metrics. The at least one wireless working channel and the at least one wireless prescreened channel can occupy the 5 gigahertz (GHz) Unlicensed National Information Infrastructure (U-NII) band. The at least one wireless working channel and the at least one wireless prescreened channel can be one of Dynamic Frequency Selection (DFS) channels and non-DFS channels. The data can be uncompressed Pulse-code Modulation (PCM) audio data.

In accordance with example embodiments of the present invention, a device for wireless data transportation is provided. The device includes a first front end for transmitting data over at least one wireless working channel, a second front end for monitoring at least one wireless prescreened channel, a radar and energy detector unit for detecting the presence of radar or energy over the at least one wireless working channel and the at least one wireless prescreened channel, and a processor controller for transitioning from the at least one wireless working channel to the at least one wireless prescreened channel when communication over the at least one wireless working channel is no longer acceptable.

In accordance with aspects of the present invention, the data is uncompressed Pulse-code Modulation (PCM) audio data. The device can further include a baseband processor to modulate or encode the data. The device can further include an antenna coupled to a coupler for providing radiofrequency (RF) data to the first front end and the second front end.

### BRIEF DESCRIPTION OF THE FIGURES

These and other characteristics of the present disclosure will be more fully understood by reference to the following detailed description in conjunction with the attached drawings, in which:

FIG. 1 is an example diagram of a system for use in accordance with aspects of the present disclosure;

FIG. 2 is an example diagram of a master device for use in accordance with aspects of the present disclosure;

FIG. 3 is an example diagram of a radar and energy processing block for use in accordance with aspects of the present disclosure;

FIG. 4 is an example diagram of a slave device for use in accordance with aspects of the present disclosure;

FIG. 5 is a flowchart depicting a process for operating a working front end in accordance with aspects of the present disclosure;

FIG. 6 is a flowchart depicting a process for operating a monitoring front end in accordance with aspects of the present disclosure; and

FIG. 7 is a diagrammatic illustration of a high-level architecture for implementing processes in accordance with aspects of the present disclosure.

### DETAILED DESCRIPTION

An illustrative embodiment of the present disclosure relates to systems and methods that implement an active detection of radiation within a radio frequency band, such as the 5 GHz Wi-Fi band. The devices within the present disclosure are designed for use within both Dynamic Frequency Selection (DFS) channels as well as the non-DFS channels within a given Wi-Fi band. The present disclosure provides flexibility of using different channel types by implementing avoidance of radar, interference energy, and poor network quality with a prioritization of all channels within both DFS and non-DFS frequency channels based on a combination of metrics. This combination of functionality can be utilized to improve how data is wirelessly transmitted between devices by more than doubling the available network capacity compared to the non-DFS channels only (which do not require radar detection). This can also lead to increased efficiency of the transmission of data as well as reliability of those transmissions by always operating over the best available channel with little to no downtime between transitions between channels when the previous channel is no longer optimal. In some embodiments, the present disclosure can be used to improve audio transmission between devices for an improved user experience because the present disclosure implements radio technology that detects radar, it can operate within the Dynamic Frequency Selection (DFS) channels as well as the non-DFS 5 GHz channels. The use of the DFS band 5.47 to 5.725 GHz adds an additional twelve 20 MHz channel that can be used for audio transmission over the thirteen 20 MHz non-DFS channel. In a crowded Wi-Fi environment, the non-DFS channels can fill up first, because radar detection is rarely implemented, leaving the DFS channels open for audio and data transmission.

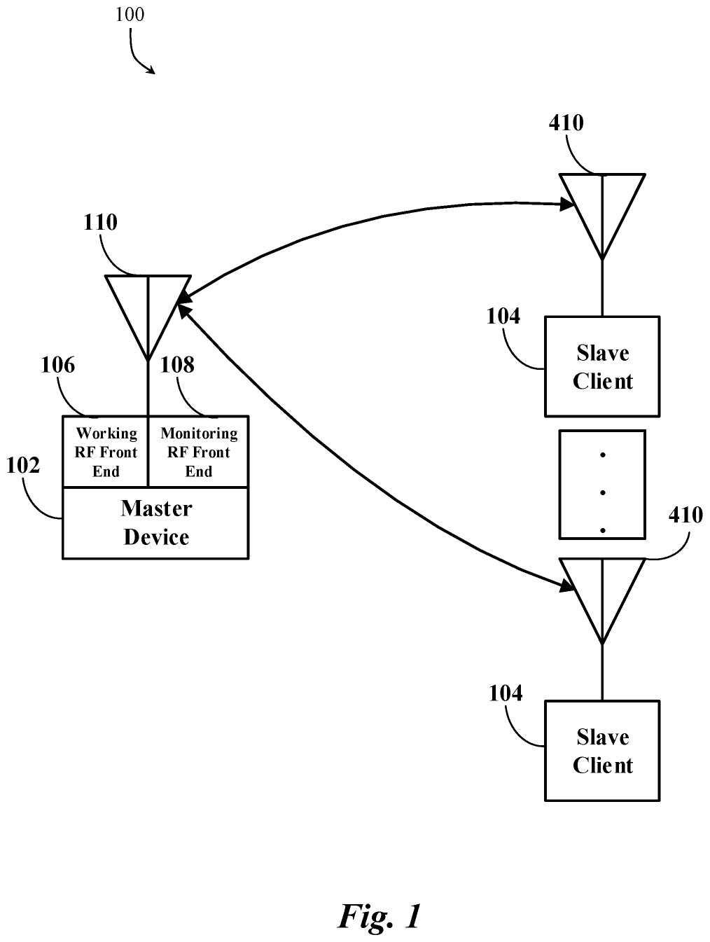

FIGS. 1 through 7, wherein like parts are designated by like reference numerals throughout, illustrate an example embodiment or embodiments of improved operation for transmitting data wirelessly over DFS and non-DFS channels, according to the present disclosure. Although the present disclosure will be described with reference to the example embodiment or embodiments illustrated in the figures, it should be understood that many alternative forms can embody the present disclosure. For example, although the present disclosure discusses the transmission of audio data, it is not intended to be limited to the transmission of audio data and can be used to transmit any combination of data (e.g., images, video, text, etc.). One of skill in the art will additionally appreciate different ways to alter the parameters of the embodiment(s) disclosed, in a manner still in keeping with the spirit and scope of the present disclosure.

Referring to FIG. 1, the present disclosure can be implemented on a system 100 including multiple differently configured devices. In some embodiments, the system 100 can include a master device 102 capable of coordinating and communicating wirelessly with one or more slave client devices 104. For example, the system 100 can include one master device 102 that controls the operating channel and one or more slave devices 104 using either Dynamic Frequency Selection (DFS) or non-DFS channels. In some embodiments, the master device 102 can provide controls to the slave devices 104, such as for example, data rates, audio volume controls, transmission power, and provides a count-down time for channel changes for the slave devices 104. The slave devices 104 can be configured to receive, follow, and respond to the controls provided by the master device 102. For example, the slave devices 104 can be audio player devices designed to receive audio data form the master device 102 and play the audio in the manner provided by the master device 102 (e.g., volume, power, etc.)

The master device 102 can include any combination of computing and/or specialized devices that is capable of coordinating and communicating data between other devices over a wireless network. Continuing with FIG. 1, in some embodiments, the master device 102 can be an access point having at least one working front end 106 (or radio) and at last one monitoring front end 108 (or radio). The working front end 106 can be used for actively transmitting data with other devices and the monitoring front end 108 can be used to scan DFS channels for radar and energy activity. In some embodiments, the working front end 106 can also monitor its own channel for radar, energy, network quality, etc. while the monitoring front end 108 can be designed to only receive data for prescreening purposes. In such an implementation, the monitoring front end 108 can be dedicated to pre-screening the next channels for transmission use by the working front end 106 in the event that the channel currently being used by the working front end 106 becomes unacceptable (e.g., radar/energy is present, falls below a given network quality threshold, etc.), as discussed in greater detail herein.

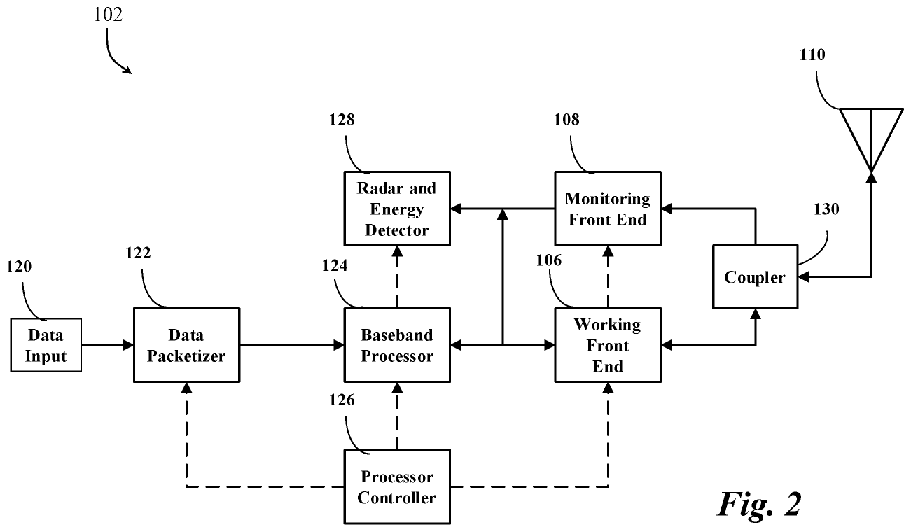

Referring to FIG. 2, in some embodiments, the master device 102 can include a specialized combination of hardware to implement the present disclosure. The master device 102 can include a combination of a data input 120, a data packetizer 122, a baseband processor 124 (e.g., an 802.11a baseband processor), a processor controller 126, a radar and energy detector 128, a working front end 106, the monitoring front end 108, and a coupler 130 connected to the antenna 110. The combination of hardware can be implemented as a single printed circuit board (PCB), individual components coupled together, or a combination thereof. Additionally, the combination of components in FIG. 2 are for illustrative example purposes and can be reduced, expanded, and substituted with similar hardware components to implement the functionality of the present disclosure.

In operation, the master device 102 can receive the data for transmission via the data input 120. For example, for audio transmission, the data input 120 can be coupled to an Inter-IC Sound (I2S) source. When data is received via the data input 120, the data can be transferred to the data packetizer 122 for assembly. For example, in some embodiments, the data packetizer 122 can implement the assembly process to add the packet header and payload into an 802.11a frame. The packet header can include the source and destination machine access control (MAC) addresses while the payload can include the control command field and the data (e.g., audio data). Thereafter, the baseband processor 124 can modulate and/or encode the data assembled by the data packetizer 122. For example, 48 samples of audio data can be placed into each 802.11a packet frame.

In some embodiments, the baseband processor 124 can also modulate and/or encode and demodulates and/or decodes control information to manage the network as required by the processor controller 126. The processor controller 126 can be designed to manage the various components of the device 102 including sending control signals, command, etc. The processor controller 126 can also be responsible for managing the operation of the device 102 itself. For example, in some embodiments, the processor controller 126 can provide audio volume, transmit power, and provides a count-down time for channel changes. The processor controller 126 can also provide control signals to the working front end 106 and monitoring front end 108. The dashed lines can represent signal transmitted by the processor controller 126 for configuration and control of the other blocks in FIG. 2.

In some embodiments, the processor controller 126 can also manage the slave devices 104 associate with the master device 102 and recover slave devices 104 when they are lost. The processor controller 126 can also provide instructions and commands to be executed by the slave devices 104. For example, the processor controller 126 can inform the slave devices 104 when audio transmission will/has started, when audio will/has stopped, and the audio data rate (e.g., 44.1, 48.0, 96.0 kHz).

Continuing with respect to FIG. 1, in some embodiments, the working front end 106 and the monitoring front end 108 can share the antenna 110 via the coupler 130 and the processor controller 126. In some embodiments, the directional coupler 130 can connect both the working front end 106 and monitoring front end 108 to the antenna 110 while also providing isolation from the working front end 106 to the monitoring front end 108. This isolation can allow the monitor front end 108 to receive the small (−62 dBm) radar signal while the working is transmitting a large (+12 dBm) Wi-Fi signal without overloading the monitor front end 108.

In some embodiments, both of the working front end 106 and the monitoring front end 108 can include or otherwise be connected to the baseband processor 124, the radar and energy detector 128, and the antenna 110. In some embodiments, each of the working front end 106 and the monitoring front end 108 can include their own antenna 110, baseboard processor 124, or radar and energy detector, etc. without departing from the scope of the present disclosure. For example, each front end 106, 108 can have its own antenna 110, may remove the need for the coupler 130. In some embodiments, the working front end 106 can include all the analog processing to up convert the complex I/Q baseband signal to a 5 GHz RF signal and down convert a 5 GHz RF signal to a complex I/Q baseband signal. The up-conversion process can include filtering of the baseband signal, mixing the baseband signal with a Local Oscillator, amplifying, and filtering the result. The down conversion process can be in the reverse; filtering the 5 GHz signal, amplifying, mixing the 5 GHz signal with the Local Oscillator, and filtering the baseband signal.

In some embodiments, the broadband processor 124, the working front end 106, and the monitoring front end 108 are each connected to the radar and energy detector 128 For example, the radar and energy detector 128 can support dual inputs, alternatively, there can be separate radar and energy detector 128 engines for each front end. The radar and energy detector 128 designed to receive information from the working front end 106 and the monitoring front end 108 and determine whether radar and/or energy is present on channels associated with that information. If the radar and energy detector 128 identifies radar and/or energy on the channels being used and/or monitored by the working front end 106 and the monitoring front end 108, then the radar and energy detector 128 can notify (e.g., notification, alert, etc.) the front ends 106, 108 directly or through the broadband processor 124.

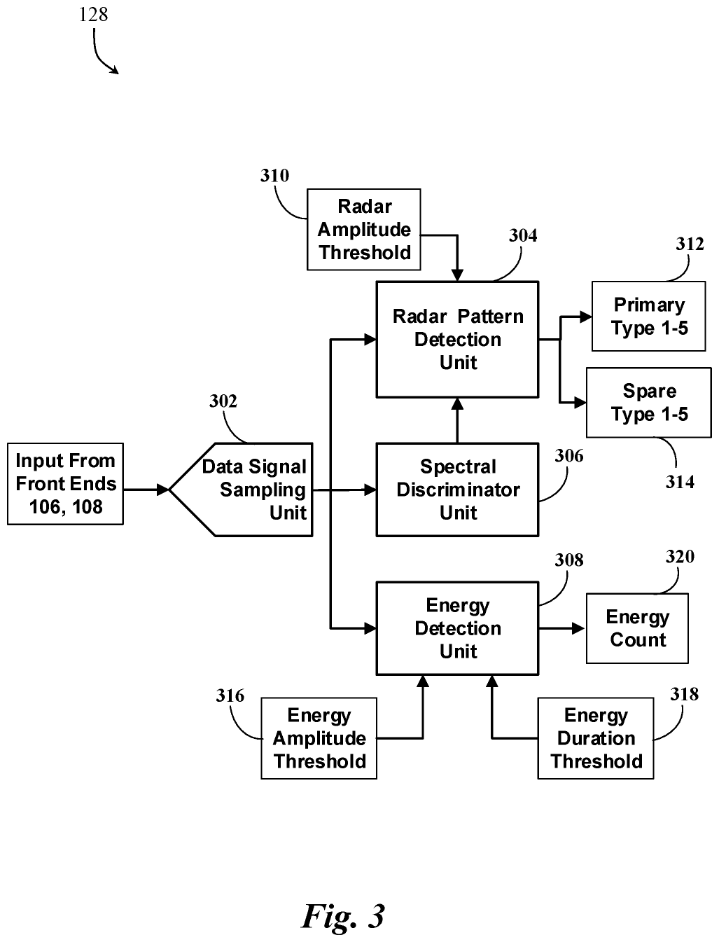

Referring to FIG. 3, an illustrative example of the radar and energy detector 128 and its operation is depicted. In some embodiments, the radar and energy detector 128 can take the radio frequency (RF) signal inputs from the working front end 106 and the monitoring front end 108 and determine if there is active radar across DFS channels as provided in FIG. 3. In some embodiments, the monitoring front end 108 and the working front end 106 can be configured to operate at different frequency channels such and the signals are not combined. Using the information received from both front ends, the radar and energy detector 128, can determine which channel the working front end 106 should be using. For example, if there is a DFS channel available and the working front end 106 is transmitting over a non-DFS channel that may have lower network quality.

In operation, the RF inputs can be received by the radar and energy detector 128 at a data signal sampling unit 302, for example, an I/Q analog-to-digital converter (ADC) unit. The data single sampling unit 302 can be used to show changes in magnitude, amplitude, and phase of a signal. In some embodiments, the ADC can sample the received RF baseband signal and convert them into a digital stream(s). The digital stream(s) is then available for digital signal processing, such as, power/energy detection, spectral analysis, and amplitude slicing for pattern detection. In some embodiments, data signal sampling unit 302 output can be converted to a power value first P=I\hat{ }2+Q\hat{ }2. The values for the magnitude, amplitude, and phase, and changes thereto, can be used as inputs to other components of the radar and energy detector 128 to determine if radar or other energies are present within a signal.

In some embodiments, a radar pattern detection unit 304 and a spectral discriminator unit 306 of the radar and energy detector 128 can be designed to use three signal properties to identify the presence of radar over a channel. The three signal properties can include a signal amplitude, instantaneous spectral bandwidth, and signal pattern. The radar pattern detection unit 304 can compare a radar signal amplitude (e.g., from the data signal sampling unit 302) to a radar amplitude threshold 310 value stored in memory to determine if there is radar present. For example, the radar threshold can be approximately −62 dBm such that signals that are much larger or smaller than that threshold value would not be considered to contain radar.

In some embodiments, the spectral discriminator unit 306 can also perform an instantaneous spectral bandwidth analysis of the signal to discriminate between radar and other Orthogonal Frequency Domain Multiplexing (OFDM) and noise like signals. The spectral discriminator unit 306 can identify instantaneous spectral bandwidth using any combination of systems and methods. For example, the instantaneous spectral bandwidth can be identified using the system and method discussed in U.S. Pat. No. 8,660,219, incorporated herein by reference. The system and method in U.S. Pat. No. 8,660,219 can be used by the spectral discriminator unit 306 to distinguish between an OFDM signal and a radar signal because a radar signal that has a low instantaneous bandwidth while an OFDM signal has a high instantaneous bandwidth.

In some embodiments, the radar pattern detection unit 304 can identify different radar types by identifying known patterns of Pulse Widths (PW) and Pulse Repetition Intervals (PRI) used by conventional radar formats. Identified patterns can be measured by the radar pattern detection unit 304 and compared to stored limits for different radar types. If the incoming signal (e.g., from one of the front ends 106, 108) meets the PW and PRI window, amplitude window, for a particular type of radar, then the radar pattern detection unit 304 can report a radar detection for a particular channel. For example, if the radar and energy detector 128 determines that radar is present over a given channel it can issue a notification or interrupt (e.g., if channel is currently in use) to indicate that said channel is being used by radar. In some embodiments, the radar energy detection unit 308 can also output the radar types. For example, the radar energy detection unit 308 can output primary type 1-5 312 and spare type 1-5 314 data outputs to one of the front ends 106, 108 or the baseband processor 124. The primary type 1-5 and spare type 1-5 can correspond to a regulatory radar test signal type that are applied for certification. The primary types can be currently used and the spares type can be for future needs.

In some embodiments, an energy detection unit 308 of the radar and energy detector 128 can perform energy detection using three signal properties. Energy detection is used to determine if a specific channel is occupied by other devices and will generate sufficient interference to disrupt the transfer of audio/data. In some embodiments, the energy detection unit 308 can use three signal properties, including an energy amplitude threshold 316, an energy duration threshold 318, and a signal count threshold, to determine the presence of energy over a channel. The thresholds for the three signal properties can each be assigned to in such a manner that signifies that there may be energy detected on a channel. For example, the energy amplitude threshold 316 is approximately −75 dBm, the energy duration threshold 318 is approximately 100 usec, and the signal count threshold is approximately 20 per second. When all three thresholds are exceeded, the energy detection unit 308 can determine that energy is detected and it can report the energy detection to the radar and energy detector 128. For example, if the energy detection unit 308 determines that energy is present over a given channel it can issue a notification, alert, or interrupt (e.g., if channel is currently in use) to indicate that said channel is being used by energy. In some embodiments, the radar energy detection unit 308 can also output an energy count 320 to one of the front ends 106, 108 or the baseband processor 124. The energy count 320 can designate how often an energy event happens, for example, 20 energy events per second can be the current threshold for action. Any outputs from the radar and energy detector 128 can be stored for further use and/or analysis (e.g., by the baseband processor 124, processor controller 126, etc.).

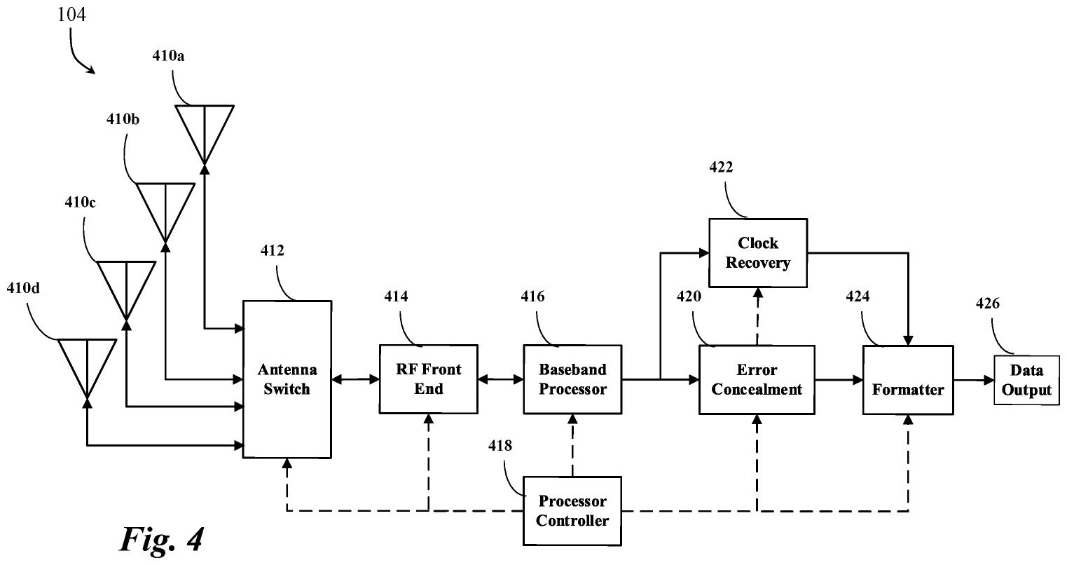

Referring to FIG. 4, an example embodiment of a slave device 104 is depicted. In some embodiments, each slave device 104 can include four antennas 410a, 410b, 410c, 410d connected through an antenna switch 412 to an RF front end 414. The four antennas 410a, 410b, 410c, 410d can provide enough spatial diversity to maintain a robust RF link between the master device 102 and the slave client device 104. For example, testing with four-antenna diversity in a 10×10 meter room, including typical home furnishings, yielded a 99.9% probability that slave client devices 104 can be placed in any location without a data communication link failure. Although four antennas are provided herein, any combination of antennas can be used without departing from the scope of the present disclosure. Regardless the number of available antennas, the antenna switch 412 can allow the slave device 104 to select which antenna to use and whether to use each antenna as a transmitter, receiver, or transceiver. Other methods to improve spatial diversity can be used without departing from the scope of the present invention. For example, a Multiple-Input-Multiple-Output (MIMO) antenna architecture can be used, however, may require addition master and slave front end and baseband hardware.

In some embodiments, the slave devices 104 can include an RF front end 414 that is similar to the working front end 106 of the master unit 102. The RF front end 414 can be connected to a baseband processor 416, for example, an 802.1a baseband processor. The baseband processor 416 can be designed to demodulate and/or decode data received from the master device 102 (via antennas 410a, 410b, 410c, 410c). For example, the baseband processor 416 can receive and demodulate and/or decode audio data that was transmitted by the master device 102 to the slave device 104. The baseband processor 416 can also modulate and/or encode and demodulate and/or decode control information to coordinate a network with the master device 102.

In some embodiments, the raw data from the baseband processor 416 can be transmitted to an error concealment block 420 where any missing data is interpolated from the received data or replaced with similar recent stored data. The packet timing information from the baseband processor 416 can also be transmitted to a clock recovery block 422 where a clock (e.g., a I2S MCLK for audio data) can be recreated using a Phase Lock Loop (PLL). The packet timing information can be provided by the frame arrival timing datum.

In some embodiments, the packet timing information and clock can then be formatted by a formatter 424 as the output 426 (e.g., an I2S serial audio standard output). For example, the output 426 can be a I2S signal that can contain a serial bit clock (SCLK), one or more serial data signals (SDATA0, SDATA1, . . . ), a word synchronization signal (WS), and an optional master clock (MCLK) for general audio clock usage. In some embodiments, this technology can operate in conjunction the audio interleaving and interpolation scheme discussed in U.S. Pat. No. 9,454,968, incorporated herein, to provide a high-quality audio transport system.

In some embodiments, the slave device 104 can include a processor controller 418 which shares similar functionality as that of processor controller 126 discussed with respect to FIG. 2. Similarly, to the processor controller 126, the dashed lines can represent signal, commands, instructions, etc. transmitted by the processor controller 418 for configuration and control of the other blocks in FIG. 4.

Continuing in reference to FIG. 4, the combination of hardware can be implemented as a single printed circuit board (PCB), individual components coupled together, or a combination thereof. Additionally, the combination of components in FIG. 4 are for illustrative example purposes and can be reduced, expanded, and substituted with similar hardware components to implement the functionality of the present disclosure.

In operation, in some embodiments, the master device 102 can coordinate wireless transmission of audio data from an audio source (e.g., via input 120) and other communication data to one or more slave devices 104. During operation, in some embodiments, the master device 102 can use the working front end 106 to transmit commands and the audio data to the one or more slave devices 104 (for playing) within a network while using the monitoring front end 108 to monitor both the active working channel and other available channels for radar and/or energy interference. In some embodiments, the working front end 106, during data transmission, can also monitor its working channel (the active channel) for radar and energy interference, as well as querying each client slave device 104 for their respective network quality metrics. The master device 102 can determine whether to change the channel based on the combination of the radar, energy, and network quality metrics observed at the working front end 106.

In some embodiments, the master device 102 can also modify how the working front end 106 and monitoring front end 108 are monitoring the active working channel and prescreening channels. For example, for DFS channels, because the Wi-Fi DFS band can be shared with commercial and military radars, the master device 102 can first ensure that the channel has been monitored (by one of the front ends 106, 108) for 60 seconds (Channel Availability Check, or CAC) without finding a radar signal before the device 102 can transmit on that channel to adhere to regulations. If a radar signal is detected, either while scanning available channels or while actively transmitting over a working channel, the master device 102 and slave devices 104 must exit and stay off that channel for 30 minutes (Non-Occupancy Period). The master device 102 can also provide notification to the slave devices 104 that the channel must be exited and will provide a new channel.

In some embodiments, each channel can be assigned a non-occupancy count-down counter. When a channel is exited, that channel's count-down counter can be seeded with a non-occupancy period, for example, expressed in seconds. The duration of the non-occupancy period can be dependent upon the reason for exiting the channel. Radar detection, for example, can result in a non-occupancy period of 1800 seconds (30 minutes*60 seconds/min=1800 seconds). The non-occupancy count-down counters can decrement at a rate of 1 count per second. While a channel's count-down counter contains a non-zero value, that channel is considered unavailable for both the working front end 106 and the monitor front end 108. Once a channel's count-down counter decrements to zero, the channel can become available again

For improved audio performance, the master device 102 can coordinate with the slave devices 104 to implement the active detection of radiation within given frequency bands and the avoidance of radar, interference energy, and poor network quality for periodization of all channels within both DFS and non-DFS frequency channels (e.g., in the 5 GHz Wi-Fi band) based on a combination of metrics.

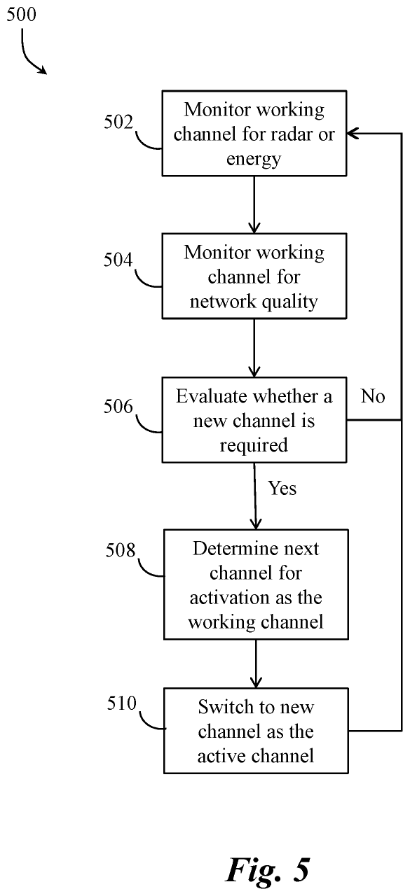

Referring to FIG. 5 an example process 500 for using the working front end 106 to monitor and change an active channel is depicted, in accordance with an example embodiment of the present disclosure. At step 502 the working front end 106 can monitor the working channel for the presence of radar or energy, for example, as discussed with respect to FIGS. 2 and 3. In other words, once the working front end 106 begins transmitting commands and data over a particular channel, it can begin monitoring that channel for radar or energy.

At step 504 the working front end 106 can monitor the working channel for the presence of other Wi-Fi devices and interferers from energy being on the channel. For example, the master device 102 can use the detector to rate available channels based on the amplitude and density of the interference. Channels with high energy amplitude/density profiles can be exited and avoided and removed or lowered on the ranking. By actively avoiding congestion, the network throughput can be greatly increased because there is little loss due to packet collision and delays in access to the 5 GHz medium. In other words, once the working front end 106 begins transmitting commands and data over a particular channel, it can begin monitoring that channel for network quality and adjust to another channel if the quality changes/decreases over time.

In some embodiments, the master device 102 can characterize network quality on any active channels between itself and one or more slave devices 104. For example, during transmission of data between one or more slave devices 104, the master device 102 can actively monitor the channel(s) for network quality and determine whether a new channel, with higher quality, should be selected. In some embodiments, the network quality metric can query each slave device 104 on a periodic interval, for example, every 50 ms. If any of the slave devices 104 return network quality metrics indicating poor network quality, for example, excessive bit error rate, packet error rate, sample/word error rate, etc. the firmware can select a new working channel. The network quality metrics can be accumulated over a configurable period of time and the master device 102 can then decide to whether leave a channel for low network quality (e.g., high bit error rate, packet error rate, sample/word error rate, etc). As would be appreciated by one skilled in the art, the monitoring steps 502, 504 can be carried out sequentially or substantially at the same time.

In some embodiments, while the radar and energy detection process can be implemented in hardware, the network quality processes can be implemented in firmware executed on the master device 102 and processor controller 418 on the slave device 104. The hardware based radar and energy detection detectors, in the presence of an offending signal (e.g., radar, energy detection, network quality, etc.), can generate an interrupt, notification, alert, etc. upon which the firmware will be alerted to select a new working channel.

Continuing with FIG. 5, at step 506, the master device 102 evaluates whether a new channel selection is required as the active channel. If the master device 102 determines that the current working channel is free from radar, energy, and has sufficient network quality then no change is needed and returns to step 502. If the master device 102 determines that the current working channel is not free from radar, energy, and/or does not have sufficient network quality then a new channel is needed and advances to step 508. In some embodiments, the evaluation step 506 can include receiving indication from the working front end 106 and/or slave device 104 that at least one of radar is present, energy is detected, and/or network quality is poor. For example, the master device 102 can receive an interrupt, notification, alert, etc. generated in response to the determination steps 502, 504. If such an indication is received, then the master device 102 can advance to step 508. In other words, once the master device 102 determines that a working channel change is required, regardless of the reason (e.g., radar, energy detection, network quality, etc.), the master device 102 can advance to step 508 to determine the next working channel.

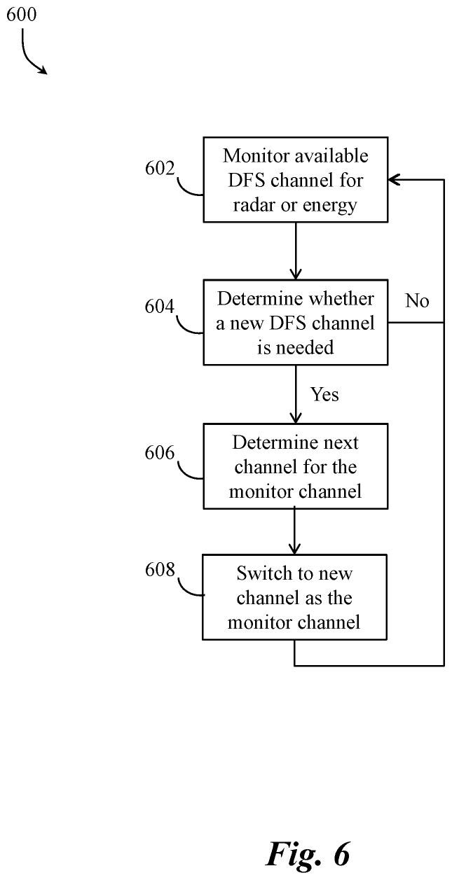

At step 508, the master device 102 determines whether a DFS channel has been verified to be free of radar and energy detection. For example, the master device 102 can check with the monitoring front end 108 to see if a DFS channel as being verified, as discussed in greater detail with respect to FIG. 6. If the monitoring front end 108 has designated a DFS channel that is free from radar and energy detection, the master device 102 selects that channel as the next channel for activation. If there is no verified DFS channel, then the master device 102 checks to see if all non-DFS channels have been ranked, as discussed in greater detail herein. If all the non-DFS channels have been ranked, then the master device 102 will select the highest ranked non-DFS channel for activation. If not all the non-DFS channels have been ranked, then the master device 102 will select a pseudo-randomly selected channel from a pool of Non-DFS channels that have not yet been activated for activation.

At step 510 the next working channel selected by the master device 102 in step 508 is activated and the working channel is transitioned over to the new working channel. The next channel will be one of a verified DFS channel (pre-screened by the monitor front end 108 as discussed with respect to FIG. 6), the top ranked non-DFS channel (if all non-DFS channels have been ranked), or a randomly selected non-DFS channel. Since the next working channel is already determined as one of a verified DFS channel, a ranked non-DFS channel or a random non-DFS channel, the transition is quick (e.g., 1 ms).

In some embodiments, as part of step 510, a count-down time control for channel changes can be used to notify any slave devices 104 communicating on an expiring working channel that a new channel will be used prior to when in a future the channel change occurs (in milliseconds). The countdown can be approximately 10 ms to make sure that all slave devices 104 receive the notification. In some embodiments, the notifications can be sent multiple time (e.g., 10 times) and decremented on each send (10, 9, 8, 7, . . . 1 ms). The slave devices 104 only need to receive one of the notifications to determine the switching time, and then all front ends (e.g., radios) on all devices (master and slave) can simultaneously switch channels. Thereafter, the process 500 will return to the monitoring steps 502, 504 and repeat as needed.

Using the process 500, when the active channel is determined to be unsuitable for audio/data transmission for any reason(s), the working front end 106 can move to another DFS channel that has been prescreened, for example, by the monitoring process 600. For example, if the network quality has fallen below a given threshold, working front end 106 can trigger an instruction to change channels. Because the next DFS channel is already prescreened (as the monitored channel) and verified, the system can change channels quickly (within 1 ms) and avoid any loss of audio/data. Otherwise the working front end 106 would have to monitor the channel for at least 60 seconds before it can proceed using that channel and if that channel was not valid it would have to wait another 60 seconds prescreening another DFS channel, etc.

Referring to FIG. 6, a process 600 for the monitoring front end 108 prescreening available channels is depicted, in accordance with some example embodiments of the present disclosure. In some embodiments, the sole purpose of the monitoring front end 108 is to scan/search for a DFS channel that is free of radar and energy. If while prescreening radar or energy is detected, the monitor radio 108 can move to the next valid DFS channel and continue.

At step 602 the monitoring front end 108 can monitor an available DFS channel for radar and/or energy. Similar to the working front end 106, the monitoring front end 108 can use the radar and energy detector unit 128 for detecting the presence of radar or energy on the DFS channel, as discussed with respect to FIGS. 2 and 3. Once a DFS channel has been verified to be free from radar and energy, the monitoring front end 108 can continue to monitor that channel until that channel becomes unverified (radar or energy is detected) and/or the working front end 106 transfers the monitored channel as the working channel. If a monitored channel that was previously verified becomes unverified, the process 602 will start over with a new DFS channel.

At step 604 the master device 102 can determine whether a new monitor DFS channel is needed. A new monitor DFS channel can be needed when the channel becomes unverified (e.g., radar or energy is present over that channel) and/or the working front end 106 transfers the previously monitored channel as the new working channel. In some embodiments, similar to the working front end 106, the monitoring front end 108 can also contain hardware based radar and energy detector unit 128 that will, in the presence of an offending signal, generate an interrupt upon which the firmware will be trigger the device 102 to select a new monitor channel. Unlike the working front end 106, network quality may not apply to the monitoring front end 108 when determining that a new monitoring channel is needed because it is not exchanging data with another device (e.g., slave device 104). When it is determined that a new monitor channel is needed, the process 600 advances to step 606.

At step 606, once the master device 102 determines that a monitored channel change is required, regardless of the reason (e.g., radar, energy detection, etc.), the master device 102 can initiate steps to determine the next monitor channel. If the master device 102 determines that all DFS channels have been ranked and if all DFS channels are in a Non-Occupancy Period (all have had radar detection within the last 30 minutes), then the master device 102 can select the highest ranked non-DFS channel. In some embodiments, during the activation, the master device 102 can disable radar and energy detection interrupts on the monitor radio 108, wait until a DFS channel has cleared the predetermined Non-Occupancy Period (e.g., 30 minutes), and enable radar and energy detection interrupts on the monitor radio 108. Interrupts can be disabled as a channel is exited (just before leaving the channel) then enabled again after activating a new channel. If the master device 102 determines that all DFS channels have not yet been ranked, the master device 102 can select a pseudo-randomly selected channel from a pool of DFS channels that have not yet been monitored for activation.

At step 608 the next monitor channel selected by the master device 102 in step 606 is activated and monitored. Thereafter, the process 600 will return to the monitoring step 602 and repeat as needed. As would be appreciated by one skilled in the art, although discussed herein each monitoring front end 108 can actively scan/monitor a given channel at a time, multiple monitoring front ends 108 could be used to simultaneously monitor multiple channels.

In some embodiments, non-DFS channels can be ranked, as they are used, based on the accumulated time that each channel has been active on a working front end 106 and/or historic performance of those channels. In some embodiments, utilization of the non-DFS channel ranking can be activated when all these channels have been used at least once. Before the ranking is complete, during initial startup for example, the non-DFS channels can be selected randomly until all channels have been used by the working front end 106. In some embodiments, because the network conditions can vary over time, and the previous duration history can become invalid, in some embodiments, the algorithm can periodically compress the duration history time spacing to a predetermined time increment. This maintains the current ranking but diminishes the separation of the ranking levels to allows the channel ranking to adapt to a new network condition easily without losing the old ranking.

To perform the channel rankings, the working front end 106 and the monitoring front end 108 receives baseband signals over the air and provides them to the other components of the device 102 for processing. For example, the working front end 106 and the monitoring front end 108 can receive RF signals over different frequencies and/or channels and analyze those channels. In some embodiments, both the working front end 106 and the monitoring front end 108 can provide baseband signals to the radar and energy detector 128 while the working front end 106 also provides signals to the baseband processor 124. With the signals obtained and transferred to the appropriate hardware, the signals can be analyzed and ranked.

In some embodiments, the baseband signals delivered by the front ends are evaluated for presence of energy and radar detection, as well as net quality metrics in the case of the working radio, affect the amount of time that a channel is active. The amount of time that a channel is active determines a channel's ranking. In some embodiments, the non-DFS channels can be ranked based on the accumulated time that each channel has been active on the working front end 106. The non-DFS channel ranking can be activated when all these channels have been used at least once. In some embodiments, the DFS channels can ranked based on a combination of the accumulated time that a channel was active on the working front end 106 and the accumulated time each channel was monitored with the monitoring front end 108. Before ranking, the DFS and non-DFS channels can be selected randomly.

In one example embodiment, the present disclosure can be implemented within a wireless audio transmission system. For example, the audio system can include a master wireless access point device that uses the present disclosure to efficiently and reliably transmit audio data wirelessly to a plurality of slave client devices. The master wireless access point device can be designed to transmit uncompressed pulse-code modulation (PCM) audio data to a plurality of slave audio playing devices. The master wireless access point device can obtain the audio source via any combination of methods or systems known in the art, for example, a streaming source or a hard-wired source.

The audio data can be preferably transmitted over DFS channels and optionally non-DFS channels when no DFS channels are available (e.g., free from radar, energy, etc.) or are not verified. While transmitting the audio data, the master wireless access point device can actively scan DFS bands for radar, energy, and network quality, for example, via the monitoring and working front ends 106, 108. When scanning and using different DFS and non-DFS channels, the master wireless access point device can also prioritize channels to avoid radar, energy, and low network quality in a ranking order by creating its own ranked list of all available channels. When the master wireless access point device has to change channels, due to the present or radar or energy or low network performance, it can use any combination of DFS and non-DFS channels based on prescreening and/or their rankings.

In one example embodiment, the slave client devices can be any combination of devices capable of receiving, interpreting, and playing the received audio data. The master wireless access point device can also use the present disclosure to communicate and control actions of the slave client devices by wirelessly transmitting and receiving control and other data (e.g., volume, network quality, operating parameters, etc.). In some embodiments, the master wireless access point device can provide different audio and/or control information to, and request from, each of the slave devices in a coordinated network. For example, in an audio system, the master wireless access point device can provide different audio and control information to slave audio devices based on their positioning or orientation within a space (e.g., surround sound). The audio and control information can include Stereo up to Atmos audio content (2 to 32 speakers, etc..), audio chimes and tones, room equalization, speaker calibration, user interface commands, remote and cell phone commands, voice commands, etc.

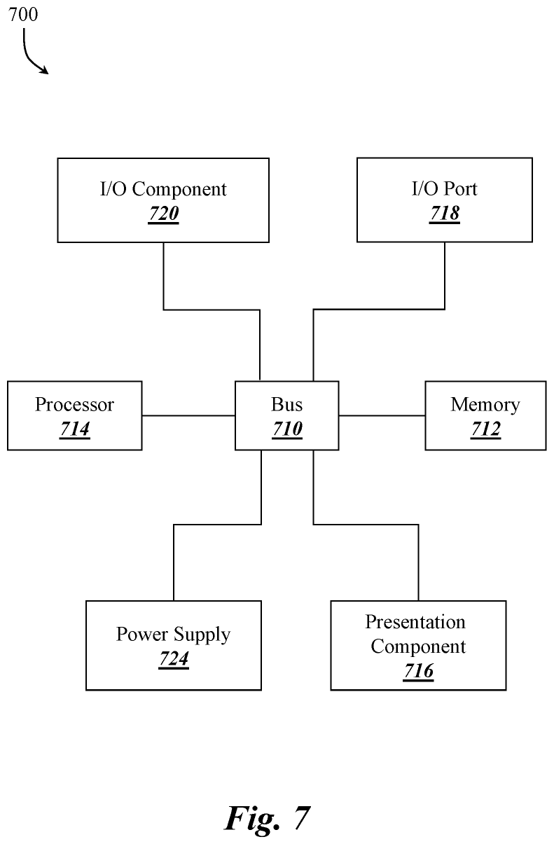

In some embodiments, any combination of the master device 102 and the slave device can be implemented within any suitable computing device that can be used to implement the methods/functionality described herein and be converted to a specific system for performing the operations and features described herein through modification of hardware, software, and firmware, in a manner significantly more than mere execution of software on a generic computing device, as would be appreciated by those of skill in the art. One illustrative example of such a computing device 700 is depicted in FIG. 7. The computing device 700 is merely an illustrative example of a suitable computing environment and in no way limits the scope of the present disclosure. A “computing device,” as represented by FIG. 7, can include a “workstation,” a “server,” a “laptop,” a “desktop,” a “hand-held device,” a “mobile device,” a “tablet computer,” or other computing devices, as would be understood by those of skill in the art. Given that the computing device 700 is depicted for illustrative purposes, embodiments of the present disclosure may utilize any number of computing devices 700 in any number of different ways to implement a single embodiment of the present disclosure. Accordingly, embodiments of the present disclosure are not limited to a single computing device 700, as would be appreciated by one with skill in the art, nor are they limited to a single type of implementation or configuration of the example computing device 700.

The computing device 700 can include a bus 710 that can be coupled to one or more of the following illustrative components, directly or indirectly: a memory 712, one or more processors 714, one or more presentation components 616, input/output ports 718, input/output components 720, and a power supply 724. One of skill in the art will appreciate that the bus 710 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 7 is merely illustrative of an exemplary computing device that can be used to implement one or more embodiments of the present disclosure, and in no way limits the invention.

The computing device 700 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CD-ROM, digital versatile disks (DVD) or other optical or holographic media; magnetic cassettes, magnetic tape, magnetic disk storage or other magnetic storage devices that can be used to encode information and can be accessed by the computing device 700.

The memory 712 can include computer-storage media in the form of volatile and/or nonvolatile memory. The memory 712 may be removable, non-removable, or any combination thereof. Exemplary hardware devices are devices such as hard drives, solid-state memory, optical-disc drives, and the like. The computing device 700 can include one or more processors that read data from components such as the memory 712, the various I/O components 716, etc. Presentation component(s) 716 present data indications to a user or other device. Exemplary presentation components include a display device, speaker, printing component, vibrating component, etc.

The I/O ports 718 can enable the computing device 700 to be logically coupled to other devices, such as I/O components 720. Some of the I/O components 720 can be built into the computing device 700. Examples of such I/O components 720 include a microphone, joystick, recording device, game pad, satellite dish, scanner, printer, wireless device, networking device, and the like.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about”, “generally”, and “approximately” are intended to cover variations that may existing in the upper and lower limits of the ranges of subjective or objective values, such as variations in properties, parameters, sizes, and dimensions. In one non-limiting example, the terms “about”, “generally”, and “approximately” mean at, or plus 10 percent or less, or minus 10 percent or less. In one non-limiting example, the terms “about”, “generally”, and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present disclosure will be apparent to those skilled in the art in view of the foregoing description. Accordingly, this description is to be construed as illustrative only and is for the purpose of teaching those skilled in the art the best mode for carrying out the present disclosure. Details of the structure may vary substantially without departing from the spirit of the present disclosure, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present disclosure be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A method for wireless data transportation, the method comprising:
monitoring, by the working front end, over at least one wireless working channel for at least one of radar, energy, and network quality;
evaluating, by the working front end, the at least one wireless working channel for acceptability of communications based on the monitoring; and
switching, by the working front end, the at least one wireless working channel to a next wireless channel when the at least one wireless working channel is not acceptable for communications.

2. The method of claim 1, wherein the at least one wireless working channel and the next wireless channel occupy the 5 gigahertz (GHz) Unlicensed National Information Infrastructure (U-NII) band.

3. The method of claim 1, wherein the at least one wireless working channel and the next wireless channel are one of Dynamic Frequency Selection (DFS) channels and non-DFS channels.

4. The method of claim 1, further comprising selecting the next wireless channel from a ranked list of Dynamic Frequency Selection (DFS) channels and non-DFS channels.

5. The method of claim 1, wherein the data is audio data.

6. The method of claim 5, wherein the data is uncompressed Pulse-code Modulation (PCM) audio data.

7. A method for prescreening wireless channels for data transportation, the method comprising:
monitoring, by a monitoring front end, a Dynamic Frequency Selection (DFS) channel for at least one of radar and energy;
identifying, by the monitoring front end, the presence of radar or energy over the DFS channel;
determining, by the monitoring front end, a next DFS channel; and
switching, by the monitoring front end, the monitoring of the DFS channel to the next DFS channel.

8. The method of claim 7, wherein the DFS channel and the next DFS channel occupy the 5 gigahertz (GHz) Unlicensed National Information Infrastructure (U-NII) band.

9. The method of claim 7, further comprising selecting the next DFS channel from a ranked list of DFS channels.

10. The method of claim 9, further comprising:
determining that radar has been detected over the next DFS from the ranked list of DFS channels over a predetermined period of time; and
selecting a next channel in the ranked list of DFS channels that radar has not been detected over the predetermined period of time.

11. The method of claim 7, wherein the next DFS channel is monitored for 60 seconds without finding a radar signal before switching the DFS channel to the next DFS channel.

12. A system for data transportation over a wireless network, the system comprising:
a master device comprising:
a first front end for transmitting data over at least one wireless working channel;
a second front end for monitoring at least one wireless prescreened channel;
a radar and energy detector unit for detecting the presence of radar or energy over the at least one wireless working channel and the at least one wireless prescreened channel; and
a baseband processor for transitioning from the at least one wireless working channel to the at least one wireless prescreened channel when communication over the at least one wireless working channel is no longer acceptable; and
at least one slave device for receiving the data over the at least one wireless working channel.

13. The system of claim 12, wherein the at least one slave device comprises an RF front end for providing network quality metrics.

14. The method of claim 12, wherein the at least one wireless working channel and the at least one wireless prescreened channel occupy the 5 gigahertz (GHz) Unlicensed National Information Infrastructure (U-NII) band.

15. The method of claim 12, wherein the at least one wireless working channel and the at least one wireless prescreened channel are one of Dynamic Frequency Selection (DFS) channels and non-DFS channels.

16. The method of claim 12, wherein the data is uncompressed Pulse-code Modulation (PCM) audio data.

17. A device for wireless data transportation, the device comprising:
a first front end for transmitting data over at least one wireless working channel;
a second front end for monitoring at least one wireless prescreened channel;
a radar and energy detector unit for detecting the presence of radar or energy over the at least one wireless working channel and the at least one wireless prescreened channel; and
a processor controller for transitioning from the at least one wireless working channel to the at least one wireless prescreened channel when communication over the at least one wireless working channel is no longer acceptable.

18. The device of claim 17, wherein the data is uncompressed Pulse-code Modulation (PCM) audio data.

19. The device of claim 17, further comprising a baseband processor to modulate or encode the data.

20. The device of claim 17, further comprising an antenna coupled to a coupler for providing radiofrequency (RF) data to the first front end and the second front end.
